(19) United States
(12) Patent Application Publication
(10) Pub. No.: US 2010/0220893 A1
(43) Pub. Date: Sep. 2, 2010

(54) Method and System of Mono-View Depth Estimation

(76) Inventors: GWO GIUN LEE, Tainan (TW); MING-JIUN WANG, Tainan (TW); LING-HSIU HUANG, Tainan (TW)

Correspondence Address: STOUT, UXA, BUYAN & MULLINS LLP, 4 VENTURE, SUITE 300, IRVINE, CA, 92618, US

(21) Appl. No.: 12/396,363

(22) Filed: Mar. 2, 2009

(51) Int. Cl. G06K 9/00; G06T 15/20

(52) U.S. Cl. 382/106; 345/427

(57) ABSTRACT

A method and system of mono-view depth estimation are disclosed. A two-dimensional (2D) image is first segmented into a number of objects. A depth diffusion region (DDR), such as the ground or a floor, is then detected among the objects. The DDR generally includes a horizontal plane. The DDR is assigned the depth, and each object connected to the DDR is assigned depth according to the depth of the DDR at the connected site.

### BACKGROUND OF THE INVENTION

1. Field of the Invention

The present invention generally relates to mono-view depth estimation, and more particularly to a ground model for mono-view depth estimation.

2. Description of the Prior Art

When three-dimensional (3D) objects are mapped onto a two-dimensional (2D) image plane by prospective projection, such as with an image taken by a still camera or video captured by a video camera, a substantial amount of information, such as the 3D depth information, disappears because of the non-unique many-to-one transformation. Accordingly, an image point cannot uniquely determine its depth. Recapture or generation of the 3D depth information is thus a challenging task that is crucial in recovering a full, or at least an approximate, 3D representation.

In mono-view depth estimation, depth may be obtained from the monoscopic spatial and/or temporal domain. The term “monoscopic” or “mono” is used herein to refer to a characteristic in which the left and right eyes see the same perspective view of a given scene. One of the known mono-view depth estimation methods is performed by extracting the depth information from the degree of object motion, and is thus called a depth-from-motion method. The object with a higher degree of motion is assigned smaller (or nearer) depth, and vice versa. Another one of the conventional mono-view depth estimation methods is performed by assigning larger (or farther) depth to non-focused regions such as the background, and is thus called a depth-from-focus-cue method. A further conventional mono-view depth estimation methods is performed by detecting the intersection of vanishing lines, or vanishing point. The points approaching the vanishing point are assigned larger (or farther) depth, and vice versa.

As very limited information may be obtained from the monoscopic spatio-temporal domain, the conventional methods mentioned above, unfortunately, cannot solve all of the scene-contents in a real-world video/image. For the foregoing reason, a need has arisen to propose a novel depth estimation method generally for a versatile mono-view video/image.

### SUMMARY OF THE INVENTION

In view of the foregoing, it is an object of the present invention to provide a ground model method and system for mono-view depth estimation, which is capable of providing correct and versatile depth and handling of a relatively large (i.e., great) variety of scenes whenever a depth diffusion region (DDR) is present or can be identified.

According to one embodiment, a two-dimensional (2D) image is first segmented into a number of objects. A DDR, such as for example the ground or a floor, is then detected among the objects. The DDR generally includes a region or relatively planar region that is about horizontal (e.g., a horizontal plane). The DDR is assigned a depth, such as for example, a depth monotonically increasing from bottom to top of the DDR. An object connected to the DDR is assigned depth according to the depth of the DDR at the connected location. For example, the depth of the connected object is assigned the same depth of the DDR at the connected location.

### BRIEF DESCRIPTION OF THE DRAWINGS

FIG. 1 illustrates a flow diagram demonstrating the steps of a mono-view depth estimation method based on a ground model according to one embodiment of the present invention;

FIG. 2 illustrates an associated block diagram of a mono-view depth estimation system according to the embodiment of the present invention; and

FIG. 3 shows an exemplary image, in which a golfer stands on the ground or other surface capable of serving as a depth diffusion region (DDR).

### DETAILED DESCRIPTION OF THE INVENTION

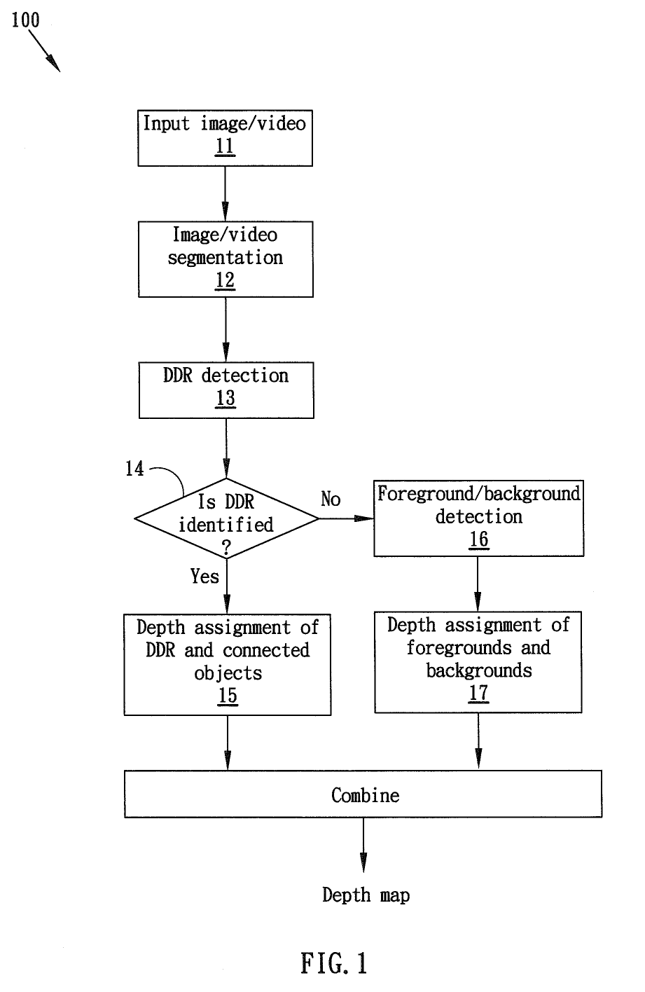

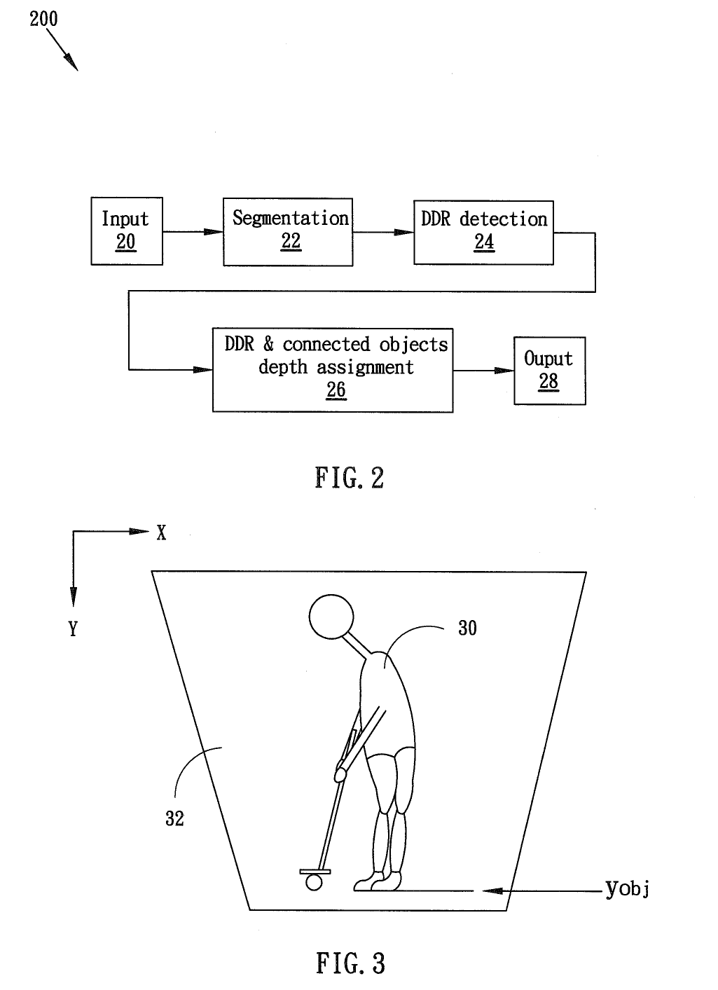

FIG. 1 illustrates a flow diagram demonstrating the steps of a mono-view depth estimation method 100 based on a ground model according to one embodiment of the present invention. FIG. 2 illustrates an associated block diagram of a mono-view depth estimation system 200 according to the embodiment of the present invention.

In step 11, an input device 20 provides or receives one or more two-dimensional (2D) input images to be image/video processed in accordance with the embodiment of the present invention. The input device 20 may in general be an electro-optical device that maps 3D object(s) onto a 2D image plane by prospective projection. In one embodiment, the input device 20 may be a still camera that takes the 2D image, or a video camera that captures a number of image frames. The input device 20, in another embodiment, may be a pre-processing device that performs one or more of digital image processing tasks, such as image enhancement, image restoration, image analysis, image compression or image synthesis. Moreover, the input device 20 may further include a storage device, such as a semiconductor memory or hard disk drive, which stores processed images from the pre-processing device. As discussed above, a relatively large amount of information, such as particularly the 3D depth information, is lost when 3D objects are mapped onto the 2D image plane, and therefore according to a feature of the invention the 2D image provided by the input device 20 is subjected to image/video processing through other blocks of the mono-view depth estimation system 200, which will be discussed below.

The input image/video is then processed, in step 12, by a segmentation unit 22 that partitions the input image into multiple regions, objects or segments. As used herein, the term “unit” is used to denote a circuit, a piece of program, or their combination. In general, the method and system of the present invention may be implemented in whole or in part using software and/or firmware, including, for example, one or more of a computer, a microprocessor, a circuit, an Application Specific Integrated Circuit (ASIC), a programmable gate array device, or other hardware. The purpose of the segmentation is to change the representation of the image into something easier to assign depth to in the later steps. The pixels in the same region have similar characteristics, such as color, intensity or texture, while the pixels between adjacent regions have distinct characteristics. Step 12 may be performed using one of the conventional segmentation techniques, or may be performed using a segmentation technique to be developed in the future.

In step 13, a depth diffusion region (DDR) is detected by a DDR detection unit 24. According to the disclosed ground model of the present embodiment, the DDR may be ground (or earth), ocean, flooring or any other region or surface that is about horizontal (e.g., a horizontal plane). A horizontal plane having the same segmentation characteristics and having substantive area can, according to a feature of the invention, probably be detected as the DDR. FIG. 3 shows an exemplary image in which a golfer 30 stands on the ground (or the lawn) 32 or other region (e.g., horizontal plane or relatively horizontal surface) suitable for serving as the DDR. In this exemplary image, two objects (i.e., the ground 32 and the golfer 30) are collected through the segmentation of the previous step 12.

When a DDR is identified (i.e., the yes branch of step 14), the DDR is assigned depth in step 15 by a DDR depth assignment unit 26. The depth assignment of the DDR (for example, the ground 32) may monotonically increase from the bottom to the top. According to one feature of the invention, the depth magnitude of the DDR can be inversely proportional to a vertical dimension of the DDR or location on the DDR. The depth assignment of the DDR may be formulated as follows:

DepthDDR(y) ↑ as y ↓

or

DepthDDR=k/y

where k is a constant.

In another embodiment, depth assignment of the DDR may increase from the bottom to the top in a non-monotonic manner. For example, DepthDDR=k/(y²).

Further, the depth of the object (or objects) connected to the DDR is assigned by the depth assignment unit 26, according to the DDR depth at the connected site. Taking the image in FIG. 3 as an example, as the golfer 30 is connected to (or standing on) the DDR at the bottom of his or her feet, the depth of the golfer 30 is assigned the same depth of the DDR 32 at the connected site; that is, y_{Obj}. The depth assignment may be formulated as follows:

DepthObj=DepthDDR(y_{Obj})

Generally speaking, when a connected object rests or stands on the DDR (or the ground) at a connected point, the depth of the whole object is then assigned the same depth of the DDR at the connected or joined point.

When no DDR is identified or the object(s) are not connected to the DDR (i.e., the no branch of step 14), the image or partial image is assigned depth according to one of the conventional assignment methods or a technique to be developed in the future. In the flow diagram of FIG. 1, the foreground(s) and background(s) of the non-DDR image are detected (in step 16), followed by assigning corresponding depth to the foregrounds/backgrounds (in step 17) according to the conventional method. In general, the foreground is assigned depth values smaller than those of the background. The depth obtained from step 15 alone or together with the depth obtained from step 17 are combined (in step 18) to arrive at a final depth map.

An output device 28 receives the depth map information (e.g., the final depth map) from the DDR depth assignment unit 26 and provides a resulting or output image. The output device 28, in one embodiment, may be a display device for presentation or viewing of the received depth information (e.g., depth map information). The output device 28, in another embodiment, may be a storage device, such as a semiconductor memory or hard disk drive, which stores the received depth information. Moreover, the output device 28 may further and/or alternatively include a post-processing device that performs one or more of digital image processing tasks, such as image enhancement, image restoration, image analysis, image compression or image synthesis.

According to the embodiment discussed above, the ground model methods and systems for mono-view depth estimation are capable of providing correct and versatile depth and handling of a relatively large variety of scenes whenever a DDR is present or capable of being determined or estimated.

Although specific embodiments have been illustrated and described, it will be appreciated by those skilled in the art that various modifications may be made without departing from the scope of the present invention, which is intended to be limited solely by the appended claims.

What is claimed is:

1. A method of mono-view depth estimation, comprising:
segmenting a two-dimensional (2D) image into a plurality of objects;
detecting a depth diffusion region (DDR) among the objects, the DDR including a region or planar surface that is about horizontal;
assigning depth to the DDR; and
assigning depth to an object connected to the DDR.

2. The method of claim 1, wherein the DDR is a horizontal plane comprising ground, ocean or a floor.

3. The method of claim 1, wherein the depth assignment of the DDR monotonically increases from a bottom of the DDR to a top of the DDR.

4. The method of claim 3, wherein the depth magnitude of the DDR is inversely proportional to a vertical dimension of the DDR or location on the DDR.

5. The method of claim 1, wherein the depth of the connected object is assigned according to the depth of the DDR at a connected location.

6. The method of claim 5, wherein the depth of the connected object is assigned the same depth of the DDR at the connected location.

7. The method of claim 1, further comprising a step of mapping 3D objects onto a 2D image plane.

8. The method of claim 1, further comprising a step of storing or displaying the depth of the DDR and the connected object.

9. A system of mono-view depth estimation, comprising:
a segmentation unit configured to segment a two-dimensional (2D) image into a plurality of objects;
a depth diffusion region (DDR) detection unit configured to detect a DDR among the objects, the DDR including a region or plane that is about horizontal; and
a DDR depth assignment unit configured to assign depth to the DDR, and to assign depth to an object connected to the DDR.

10. The system of claim 9, wherein the DDR is a horizontal plane comprising ground, ocean or a floor.

11. The system of claim 9, wherein the depth assignment of the DDR monotonically increases from a bottom of the DDR to a top of the DDR.

12. The system of claim 11, wherein the depth magnitude of the DDR is inversely proportional to a vertical location.

13. The system of claim 9, wherein the system is configured to assign the depth of the connected object according to the depth of the DDR at a connected location.

14. The system of claim 13, wherein the depth of the connected object is assigned the same depth of the DDR at the connected location.

15. The system of claim 9, further comprising an input device configured to map 3D objects onto a 2D image plane.

16. The system of claim 9, further comprising an output device capable of storing or displaying the depth of the DDR and the connected object.
